(19) United States
(12) Patent Application Publication
(10) Pub. No.: US 2019/0019304 A1
(43) Pub. Date: Jan. 17, 2019

(54) MEDICAL IMAGE PROCESSING APPARATUS, METHOD, AND PROGRAM

(71) Applicant: FUJIFILM Corporation, Tokyo (JP)

(72) Inventors: Mizuki TAKEI, Tokyo (JP); Keigo NAKAMURA, Tokyo (JP)

(73) Assignee: FUJIFILM Corporation, Tokyo (JP)

(21) Appl. No.: 16/031,234

(22) Filed: Jul. 10, 2018

(30) Foreign Application Priority Data
Jul. 11, 2017 (JP) 2017-135749
Jun. 25, 2018 (JP) 2018-120294

(51) Int. Cl. G06T 7/60; G06T 7/00; G06T 7/11; G06T 7/30

(52) U.S. Cl. CPC G06T 7/60; G06T 7/0012; G06T 2207/30016; G06T 7/30; G06T 2207/10081; G06T 7/11

(57) ABSTRACT

An image acquisition unit acquires a brain image of a subject. A non-bleeding region specifying unit specifies a non-bleeding region in the brain image, and a selection unit selects a standard brain image corresponding to at least one of the shape or the size of the non-bleeding region from a plurality of standard brain images. Then, a division unit divides the brain included in the brain image into regions based on the selected standard brain image.

### CROSS REFERENCE TO RELATED APPLICATIONS

The present application claims priority under 35 U.S.C. § 119 to Japanese Patent Application No. 2017-135749 filed on Jul. 11, 2017, and Japanese Patent Application No. 2018-120294 filed on Jun. 25, 2018. The above applications are hereby expressly incorporated by reference, in their entirety, into the present application.

### BACKGROUND

### Technical Field

The present invention relates to a medical image processing apparatus, method, and program for performing registration between a brain image, such as a computed tomography (CT) image of a head of a subject, and a standard brain image, which is an image of a standard brain.

### Related Art

In recent years, advances in medical apparatuses, such as CT apparatuses and magnetic resonance imaging (MRI) apparatuses have enabled image diagnosis using high-resolution medical images with higher quality. In particular, in a case where a target part is a brain, a diseased region causing a vascular disorder, such as cerebral infarction and cerebral hemorrhage, can be specified by image diagnosis using CT images, MRI images, and the like. Therefore, appropriate treatment based on the specified result is performed.

In CT images, high absorption indicates bleeding, and low absorption indicates infarction. On the other hand, in diffusion-weighted images of the MRI, infarction indicates high absorption. Therefore, in order to diagnose a vascular disorder, it is important to accurately grasp a density distribution in a region in the brain in a brain image of a normal patient (that is, a patient with no vascular disorder) and then compare a brain image to be examined with the normal brain image. In particular, it is effective for diagnosis to perform registration between a brain image to be examined and a standard brain image divided into a plurality of regions, divide the brain image to be examined into a plurality of regions, and perform density comparison for each of the divided regions.

On the other hand, a method of detecting a bleeding region greatly different from a normal region by performing registration between a CT image of a patient's brain and a standard brain image, which is a CT image to be a standard model of the brain, and comparing CT values in the whole brain has been proposed in Automated delineation of stroke lesions using brain CT images Neurolmage: Clinical, Volume 4, 2014, Pages 540-548. In addition, JP2016-527942A has proposed a method of creating a patient-specific atlas by searching for a standard brain image corresponding to the shape and size of the patient's cerebral ventricle from a database corresponding to the age range of the patient to be examined and integrating the patient's brain image and the searched standard brain image. According to the method disclosed in JP2016-527942A, since it is possible to select a standard brain image corresponding to the shape and size of the patient's cerebral ventricle, it is possible to accurately perform registration between the brain image to be examined and the standard brain image and region division of the brain image to be examined.

However, in a case where there is bleeding in the cerebral ventricle of the patient, it is not possible to correctly detect the shape and size of the cerebral ventricle since the difference between the pixel value of the cerebral ventricle and the pixel value of a region other than the cerebral ventricle, such as brain parenchyma, is small in the brain image of the patient. In such a case, even in a case where the method disclosed in JP2016-527942A is used, the registration between the brain image to be examined and the standard brain image and the region division of the brain image to be examined cannot be accurately performed.

### SUMMARY

The invention has been made in view of the above circumstances, and it is an object of the invention to perform more accurate registration between a brain image of a subject to be examined and a standard brain image.

A medical image processing apparatus according to the invention comprises: an image acquisition unit that acquires a brain image including a brain of a subject; a storage unit that stores a plurality of standard brain images having a plurality of types of shapes and sizes; a non-bleeding region specifying unit that specifies a non-bleeding region in the brain image; a selection unit that selects a standard brain image corresponding to at least one of a shape or a size of the non-bleeding region from the plurality of standard brain images; and a division unit that divides a brain included in the brain image into regions based on the selected standard brain image.

The “non-bleeding region” means a region where bleeding is not observed or bleeding is not suspected in the brain image.

In the medical image processing apparatus according to the invention, the non-bleeding region may be one or more of at least one of a plurality of sulci, at least one of a plurality of cerebral ventricles, and at least one of a plurality of anatomical regions in a subarachnoid space.

A plurality of sulci are present in the brain. For this reason, even though there is bleeding in one of the sulci, bleeding may not be observed in other sulci. In such a case, at least one of the plurality of sulci where bleeding is not observed may be specified as a non-bleeding region.

In addition, a plurality of cerebral ventricles are present in the brain. For this reason, even though there is bleeding in one of the cerebral ventricles, bleeding may not be observed in other cerebral ventricles. In such a case, at least one of the plurality of cerebral ventricles where bleeding is not observed may be specified as a non-bleeding region.

In addition, the subarachnoid space can be divided into a plurality of anatomical regions, such as cerebral valleys and ambient cisterns. For this reason, even though there is bleeding in one of the regions, bleeding may not be observed in other regions. In such a case, at least one of the plurality of anatomical regions in the subarachnoid space where bleeding is not observed may be specified as a non-bleeding region.

In a case where there is bleeding in the sulcus, the cerebral ventricle or the subarachnoid space may be specified as a non-bleeding region. In this case, at least one of a plurality of cerebral ventricles or at least one of a plurality of anatomical regions of the subarachnoid space may be specified as non-bleeding regions.

In a case where there is bleeding in the cerebral ventricle, the sulcus or the subarachnoid space may be specified as a non-bleeding region. In this case, at least one of a plurality of sulci or at least one of a plurality of anatomical regions of the subarachnoid space may be specified as non-bleeding regions.

In a case where there is bleeding in the subarachnoid space, the sulcus or the cerebral ventricle may be specified as a non-bleeding region. In this case, at least one of a plurality of sulci or at least one of a plurality of cerebral ventricles may be specified as non-bleeding regions.

In the medical image processing apparatus according to the invention, the non-bleeding region specifying unit may specify the non-bleeding region based on diagnostic information of the subject.

In the medical image processing apparatus according to the invention, the non-bleeding region specifying unit may specify the non-bleeding region based on the brain image.

The medical image processing apparatus according to the invention may further comprise a diseased region specifying unit that specifies a diseased region including a disease in the region-divided brain image.

The medical image processing apparatus according to the invention may further comprise a display control unit that displays the brain image, in which the diseased region is specified, on a display unit.

A medical image processing method according to the invention comprises: acquiring a brain image including a brain of a subject; specifying a non-bleeding region in the brain image; selecting a standard brain image corresponding to at least one of a shape or a size of the non-bleeding region from a plurality of standard brain images having a plurality of types of shapes and sizes; and dividing a brain included in the brain image into regions based on the selected standard brain image.

In addition, a program causing a computer to execute the medical image processing method according to the invention may be provided.

Another medical image processing apparatus according to the invention comprises: a memory that stores commands to be executed by a computer; and a processor configured to execute the stored commands. The processor executes: processing for specifying a non-bleeding region in a brain image; processing for selecting a standard brain image corresponding to at least one of a shape or a size of the non-bleeding region from a plurality of standard brain images having a plurality of types of shapes and sizes; and processing for dividing a brain included in the brain image into regions based on the selected standard brain image.

According to the invention, a non-bleeding region in the brain image is specified, a standard brain image corresponding to at least one of the shape or the size of the non-bleeding region is selected, and the brain included in the brain image is divided into regions based on the selected standard brain image. Here, since a non-bleeding region is not influenced by blood, the non-bleeding region has a unique pixel value corresponding to the anatomical structure of the non-bleeding region in the brain image. Therefore, it is possible to accurately specify a non-bleeding region in the brain image. By using the non-bleeding region specified as described above, a standard brain image corresponding to at least one of the shape or the size of the brain image can be selected from the plurality of standard brain images. As a result, registration between the brain image of the subject and the standard brain image and region division of the brain image of the subject can be accurately performed.

### BRIEF DESCRIPTION OF THE DRAWINGS

FIG. 1 is a hardware configuration diagram showing an outline of a diagnostic support system to which a medical image processing apparatus according to an embodiment of the invention is applied.

FIG. 2 is a diagram showing the schematic configuration of the medical image processing apparatus according to the present embodiment.

FIG. 3 is a diagram showing a standard brain image.

FIG. 4 is a diagram showing a database in which symptoms of a patient are associated with non-bleeding regions in the brain.

FIG. 5 is a diagram illustrating a comparison between a non-bleeding region of a brain image and a non-bleeding region of each of a plurality of standard brain images.

FIG. 6 is a diagram showing a divided brain image.

FIG. 7 is a diagram showing a brain image displayed on a display.

FIG. 8 is a flowchart showing a process performed in the present embodiment.

### DETAILED DESCRIPTION

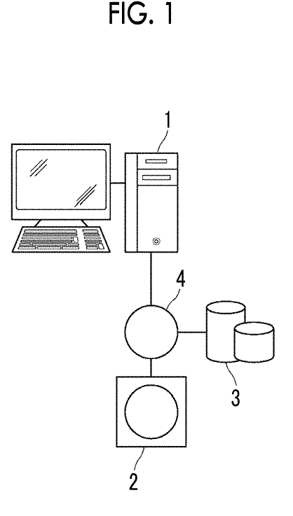

Hereinafter, embodiments of the invention will be described with reference to the diagrams. FIG. 1 is a hardware configuration diagram showing the outline of a diagnostic support system to which a medical image processing apparatus according to an embodiment of the invention is applied. As shown in FIG. 1, in the diagnostic support system, a medical image processing apparatus 1 according to the present embodiment, a three-dimensional image capturing apparatus 2, and an image storage server 3 are communicably connected to each other through a network 4.

The three-dimensional image capturing apparatus 2 is an apparatus that generates a three-dimensional image showing a part, which is a part to be examined of a subject, as a medical image by imaging the part. Specifically, the three-dimensional image capturing apparatus 2 is a CT apparatus, an MRI apparatus, a positron emission tomography (PET) apparatus, or the like. The medical image generated by the three-dimensional image capturing apparatus 2 is transmitted to the image storage server 3 and is stored therein. In the present embodiment, the diagnostic target part of a patient as a subject is the brain, and the three-dimensional image capturing apparatus 2 is a CT apparatus and generates a CT image of the head containing the brain of the subject as a three-dimensional brain image B0.

The image storage server 3 is a computer that stores and manages various kinds of data, and includes a large-capacity external storage device and software for database management. The image storage server 3 performs communication with other apparatuses through the wired or wireless network 4 to transmit and receive image data or the like. Specifically, the image storage server 3 acquires various kinds of data including the image data of the brain image BO generated by the three-dimensional image capturing apparatus 2 through the network, and stores the various kinds of data in a recording medium, such as a large-capacity external storage device, and manages the various kinds of data. The storage format of image data and the communication between apparatuses through the network 4 are based on a protocol, such as a digital imaging and communication in medicine (DICOM). In addition, a plurality of standard brain images having sizes and shapes corresponding to age are stored in the image storage server 3. The standard brain image will be described later. In addition, diagnostic information of a patient as a subject is stored in the image storage server 3. The diagnostic information is data including text information, such as the symptoms of the patient whose brain image B0 has been acquired and the findings of a doctor who has performed the diagnosis.

The medical image processing apparatus 1 is realized by installing a medical image processing program of the invention on one computer. The computer may be a workstation or a personal computer that is directly operated by a doctor who performs diagnosis, or may be a server computer connected to these through a network. The medical image processing program is recorded on a recording medium, such as a digital versatile disc (DVD) or a compact disk read only memory (CD-ROM), so as to be distributed, and is installed onto the computer from the recording medium. Alternatively, the medical image processing program is stored in a storage device of a server computer connected to the network or in a network storage so as to be accessible from the outside, and is downloaded and installed onto a computer used by a doctor as necessary.

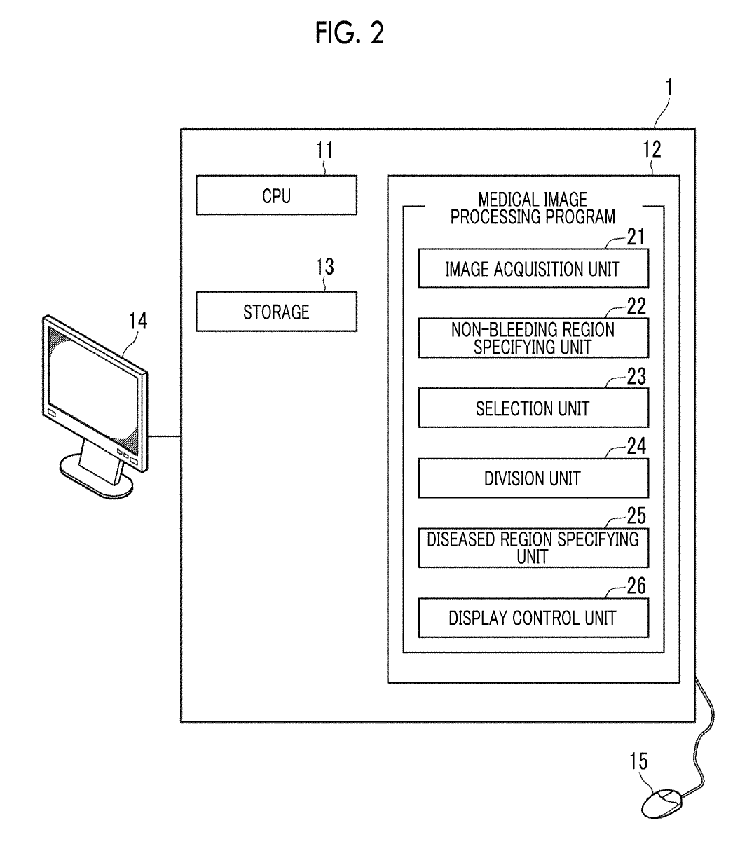

FIG. 2 is a diagram showing the schematic configuration of a medical image processing apparatus realized by installing a medical image processing program on a computer. As shown in FIG. 2, the medical image processing apparatus 1 includes a central processing unit (CPU) 11, a memory 12, and a storage 13 as the configuration of a standard workstation. A display 14 and an input unit 15, such as a keyboard and a mouse, are connected to the medical image processing apparatus 1. The display 14 corresponds to a display unit.

The storage 13 is a large-capacity recording medium, such as a hard disk drive and a solid state drive. Various kinds of information including brain images of the subject, diagnostic information of the subject, a plurality of standard brain images, and information required for processing, which are acquired from the image storage server 3 through the network 4, are stored in the storage 13. As will be described later, a database DB1 in which symptoms of a patient are associated with a non-bleeding region in the brain is also stored in the storage 13.

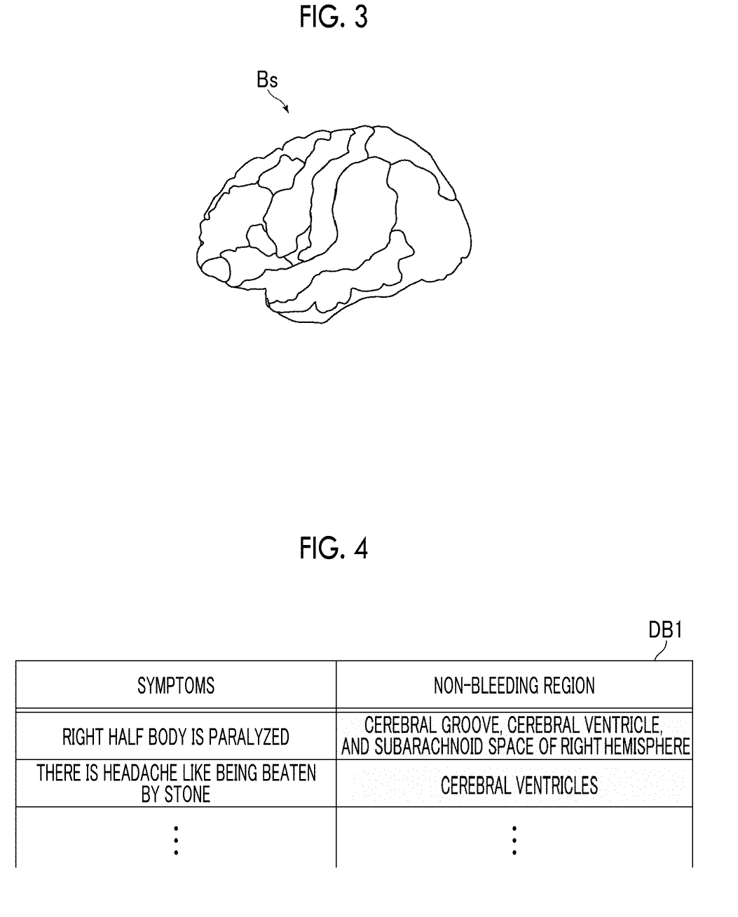

In the present embodiment, brain images of a plurality of healthy subjects are used as a plurality of standard brain images having different sizes and shapes. The standard brain image may be created by computer graphics or the like. In the present embodiment, the standard brain image is divided into a plurality of regions. As a method of division, for example, based on Broadmann's brain map, within the three-dimensional region of the cerebral cortex, it is possible to use a method of dividing the cerebral cortex into regions responsible for functions, such as movement, language, perception, memory, vision sense, and acoustic sense. In addition, it is possible to use a standard brain image divided by any known method, such as a method for division into six kinds of regions of cerebrum, diencephalon, mesencephalon, hindbrain, cerebellum, and medulla oblongata and a method of dividing the cerebrum into frontal lobe, parietal lobe, temporal lobe, and occipital lobe. A standard brain image obtained by simply dividing the brain at equal intervals may be used. FIG. 3 is a diagram showing an example of a standard brain image. In FIG. 3, a standard brain image Bs is divided into a plurality of regions according to Brodmann's brain map.

A medical image processing program is stored in the memory 12. As processing to be executed by the CPU 11, the medical image processing program defines image acquisition processing for acquiring the brain image B0 including the brain of a subject, non-bleeding region specifying processing for specifying a non-bleeding region in the brain image B0, selection processing for selecting the standard brain image Bs corresponding to at least one of the shape or the size of a non-bleeding region from a plurality of standard brain images, division processing for dividing the brain included in the brain image B0 into regions based on the selected standard brain image Bs, diseased region specifying processing for specifying a diseased region including a disease in the region-divided brain image B0, and display control processing for displaying the brain image B0 in which the diseased region is specified on the display 14.

The CPU 11 executes these processes according to the program, so that the computer functions as an image acquisition unit 21, a non-bleeding region specifying unit 22, a selection unit 23, a division unit 24, a diseased region specifying unit 25, and a display control unit 26. The medical image processing apparatus 1 may include a plurality of processors or processing circuits that perform image acquisition processing, non-bleeding region specifying processing, selection processing, division processing, diseased region specifying processing, and display control processing.

The image acquisition unit 21 acquires the brain image B0 of the brain of the subject from the image storage server 3. In a case where the brain image B0 is already stored in the storage 13, the image acquisition unit 21 may acquire the brain image B0 from the storage 13.

The non-bleeding region specifying unit 22 specifies a non-bleeding region in the brain image B0. In the present embodiment, the non-bleeding region specifying unit 22 specifies a non-bleeding region based on the diagnostic information. Therefore, the non-bleeding region specifying unit 22 acquires the diagnostic information of the patient whose brain image B0 has been acquired from the image storage server 3. Diagnostic information may be acquired in advance from the image storage server 3 and stored in the storage 13, so that the diagnostic information is acquired from the storage 13. The non-bleeding region specifying unit 22 acquires information of the symptoms of the patient in the diagnostic information. The non-bleeding region specifying unit 22 specifies a non-bleeding region with reference to the database DBI in which the symptoms of the patient are associated with a bleeding region in the brain. FIG. 4 is a diagram showing the content of the database DB1. As shown in FIG. 4, in the database DB1, the symptoms of the patient and a non-bleeding region are associated with each other. For example, in a case where the symptom is “right half body is paralyzed”, bleeding is suspected in the left hemisphere of the brain. Therefore, “sulcus, cerebral ventricle, and subarachnoid space of the right hemisphere” are associated as non-bleeding regions. In a case where the symptom is “there is a headache like being beaten by a stone”, subarachnoid hemorrhage is suspected. Therefore, “cerebral ventricles” having a low probability of occurrence of subarachnoid hemorrhage are associated as non-bleeding regions. The non-bleeding region specifying unit 22 specifies a non-bleeding region corresponding to the symptoms of the patient included in the diagnostic information with reference to the database DB1.

The non-bleeding region specifying unit 22 may specify a non-bleeding region based on the brain image B0. In this case, the non-bleeding region specifying unit 22 selects a standard brain image Bsa for region specification set in advance from a plurality of standard brain images stored in the storage 13. Then, the non-bleeding region specifying unit 22 performs registration between the brain image B0 and the standard brain image Bsa. Since the registration does not need to be performed with high accuracy, the registration may be registration using only a partial region in the brain image B0, such as matching the skull region of the brain image B0 with the skull region of the standard brain image Bsa. The non-bleeding region specifying unit 22 specifies a non-bleeding region by comparing the density of each of the sulcus, the cerebral ventricle, and the subarachnoid space of the brain image B0 after registration with the density of each of the sulcus, the cerebral ventricle, and the subarachnoid space of the standard brain image Bsa. Here, since the sulcus, the cerebral ventricle, and the subarachnoid space are usually filled with the cerebrospinal fluid, the sulcus, the cerebral ventricle, and the subarachnoid space are shown at high densities in the CT image. However, the density decreases with bleeding. Therefore, the non-bleeding region specifying unit 22 specifies a region having a density difference from the standard brain image Bsa, which is equal to or less than a predetermined threshold value Th1, in each region of the sulcus, the cerebral ventricle, and the subarachnoid space in the brain image B0, as a non-bleeding region. Alternatively, a region having a density difference from the standard brain image Bsa, which exceeds the predetermined threshold value Th1, in each region of the sulcus, the cerebral ventricle, and the subarachnoid space in the brain image B0 may be specified as a bleeding region, and a region other than the bleeding region in each region of the sulcus, the cerebral ventricle, and the subarachnoid space in the brain image B0 may be specified as a non-bleeding region.

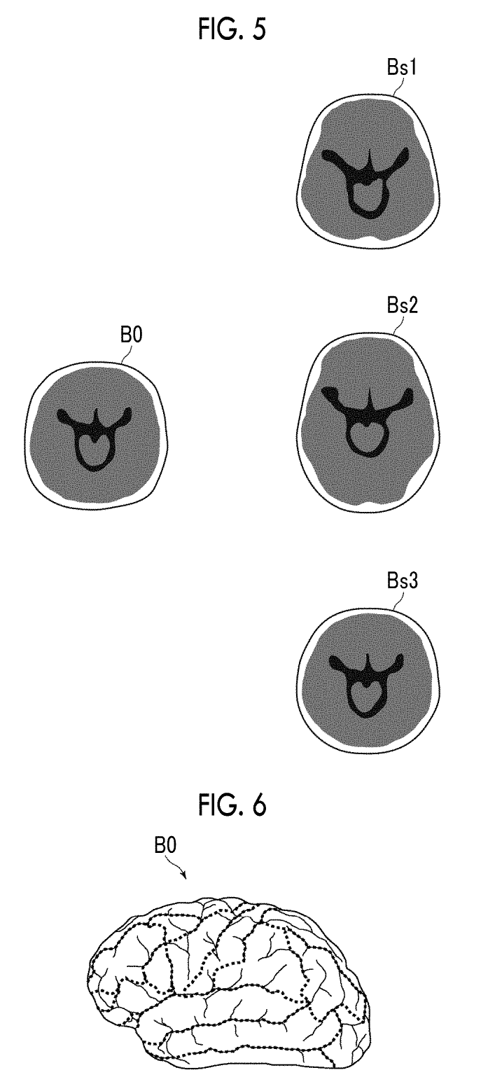

The selection unit 23 selects a standard brain image corresponding to at least one of the shape or the size of a non-bleeding region from a plurality of standard brain images. Therefore, the selection unit 23 compares the non-bleeding region of the brain image B0 with a region corresponding to each non-bleeding region of a plurality of standard brain images Bsi (i=l to n). FIG. 5 is a diagram illustrating a comparison between a non-bleeding region of a brain image and a non-bleeding region of each of a plurality of standard brain images. For the sake of explanation, it is assumed that the non-bleeding region is the subarachnoid space and the brain image B0 is compared with the three standard brain images Bs1 to Bs3. The selection unit 23 performs registration between the brain image B0 and each of the three standard brain images Bs1 to Bs3 so that the correlation value is maximized. As the correlation value, it is possible to use the reciprocal of the sum or the sum of squares of the difference values between corresponding pixel values of the brain image B0 and the standard brain image Bsi. The sum of the difference values or the sum of the squares of the difference values themselves may be used as the correlation value. In this case, registration is performed so as to minimize the correlation value. Calculating the correlation value as described above is to select a standard brain image corresponding to only the shape of the non-bleeding region or both the shape and the size of the non-bleeding region. The selection unit 23 selects a standard brain image having a maximum correlation value for the brain image B0 from the plurality of standard brain images Bs1 to Bs3. Here, it is assumed that the standard brain image Bs3 is selected. In the following description, it is assumed that Bs is used as a reference numeral of the selected standard brain image.

Alternatively, the standard brain image Bs may be selected using only the size of the non-bleeding region. For example, the length (longest portion) of the non-bleeding region of the brain image B0 in the axial direction and the length (longest portion) of each of the plurality of standard brain images Bsi in the axial direction may be compared, and the standard brain image Bs having a length in the axial direction closest to the length of the non-bleeding region of the brain image B0 in the axial direction may be selected from the plurality of standard brain images.

The division unit 24 divides the brain included in the brain image B0 into regions based on the selected standard brain image Bs. Therefore, the division unit 24 performs registration between the brain image B0 and the standard brain image Bs. The registration is performed between the three-dimensional brain image B0 and the three-dimensional standard brain image Bs. As a method of registration, first registration between the standard brain image Bs and the brain image B0 is performed first using landmarks. Then, after performing the first registration, second registration between the standard brain image Bs and the brain image B0 is performed using the entire region. As a landmark, specifically, at least one of characteristic regions, such as a sulcus and a cerebral ventricle contained in the brain, can be used. A non-bleeding region may be used as a landmark.

The division unit 24 performs the first registration between the standard brain image Bs and the brain image B0 so that the corresponding landmarks match each other. In the present embodiment, the first registration is registration by similarity transformation. Specifically, the first registration is registration by parallel movement, rotation, and similar enlargement and reduction of the brain image B0. The division unit 24 performs the first registration by performing similarity transformation of the brain image B0 so that the correlation between corresponding landmarks of landmarks included in the standard brain image Bs and landmarks of the standard brain image Bs included in the brain image B0 is maximized.

After performing the first registration using the landmark as described above, the division unit 24 performs the second registration using the entire region between the standard brain image Bs and the brain image B0. In the present embodiment, the second registration is registration by nonlinear transformation. As the registration by nonlinear transformation, for example, there is registration performed by nonlinearly converting pixel positions using functions, such as B spline and thin plate spline. The division unit 24 performs the second registration by nonlinearly converting each pixel position of the brain image B0 after the first registration to a corresponding pixel position included in the standard brain image Bs.

By performing registration between the standard brain image Bs and the brain image B0 in this manner and applying the boundary between divided regions in the standard brain image Bs to the brain image B0, the division unit 24 divides the brain image B0 into a plurality of regions, as shown in FIG. 6.

The diseased region specifying unit 25 specifies a diseased region including a disease in the region-divided brain image B0. Specifically, between corresponding regions of the divided brain image B0 and the standard brain image Bs, the distributions of pixel values (voxel values), that is, the density distributions are compared. Therefore, the diseased region specifying unit 25 fits a first density distribution, which is a density distribution in a target region (referred to as A11) of the brain image B0, and a second density distribution, which is a density distribution in a region A21 corresponding to the region A11 of the standard brain image Bs, to the probability density function of normal distribution. A density histogram of pixel values in the region A11 is used for the first density distribution, and a density histogram of pixel values in the region A21 is used for the second density distribution.

Here, in a case where the density values of all the pixels in the regions A11 and A21 are collected as samples, the average value and the variance value of the pixel values in the regions A11 and A21 can be calculated. Once the average value and the variance value are calculated, the probability density function of normal distribution can be uniquely defined. Therefore, the diseased region specifying unit 25 calculates a probability density function (hereinafter, referred to as a first probability density function) for the region A11 based on the pixel values in the region A11 of the brain image B0. In addition, the diseased region specifying unit 25 calculates a probability density function (hereinafter, referred to as a second probability density function) for the region A21 based on the pixel values in the region A21 in the standard brain image Bs.

Therefore, the diseased region specifying unit 25 fits the first density distribution to the first probability density function, and fits the second density distribution to the second probability density function. In addition, the diseased region specifying unit 25 calculates an index value indicating the difference in normal distribution between the fitted first density distribution and the fitted second density distribution. For example, Kullback-Leibler (KL)-divergence can be used as an index value indicating the difference. Then, in a case where the calculated index value exceeds a predetermined threshold value Th2, the region A11 of the brain image B0 is specified as a diseased region.

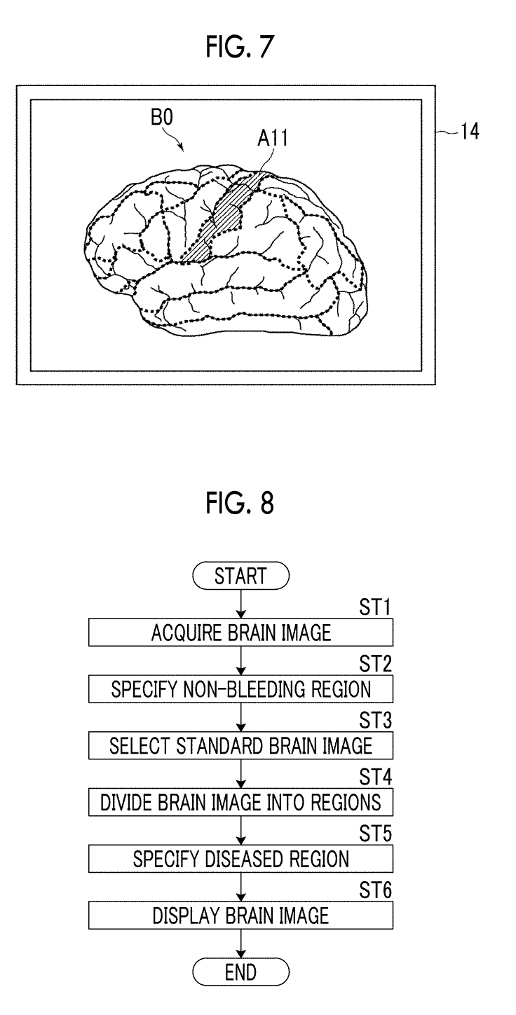

The display control unit 26 displays the diseased region in the brain image B0 specified by the diseased region specifying unit 25 on the display 14. FIG. 7 is a diagram showing a brain image displayed on the display 14. As shown in FIG. 7, in the brain image B0, the diseased region A11 is hatched. Instead of hatching, the color of the diseased region may be different from the colors of other regions, or a mark, such as an arrow, may be given to the diseased region.

Next, a process performed in the present embodiment will be described. FIG. 8 is a flowchart showing the process performed in the present embodiment. First, the image acquisition unit 21 acquires the brain image B0 of a subject (step ST1). Then, the non-bleeding region specifying unit 22 specifies a non-bleeding region in the brain image B0 (step ST2), and the selection unit 23 selects the standard brain image Bs corresponding to at least one of the shape or the size of the non-bleeding region from the plurality of standard brain images Bsi (step ST3). Then, the division unit 24 divides the brain included in the brain image B0 into regions based on the selected standard brain image Bs (step ST4), and the diseased region specifying unit 25 specifies a diseased region including a disease in the region-divided brain image B0 (step ST5). Then, the display control unit 26 displays the brain image B0, in which the diseased region is specified, on the display 14 (step ST6), and ends the process.

As described above, in the present embodiment, a non-bleeding region in the brain image B0 is specified, the standard brain image Bs corresponding to at least one of the shape or the size of the non-bleeding region is selected, and the brain included in the brain image B0 is divided into regions based on the selected standard brain image Bs. Here, since a non-bleeding region is not influenced by blood, the non-bleeding region has a unique pixel value corresponding to the anatomical structure of the non-bleeding region in the brain image B0. Therefore, it is possible to accurately specify a non-bleeding region in the brain image B0. By using the non-bleeding region specified as described above, the standard brain image Bs corresponding to at least one of the shape or the size of the non-bleeding region of the brain image B0 can be selected from the plurality of standard brain images Bs1 to Bs3. Therefore, registration between the brain image B0 of the subject and the standard brain image Bs and region division of the brain image B0 of the subject can be accurately performed.

A region where bleeding can occur in the brain differs depending on the type of bleeding. For example, subarachnoid hemorrhage tends not to occur in the cerebral ventricle. Intracerebral hemorrhage often occurs outside the subarachnoid space. Therefore, by setting one or more of at least one of a plurality of sulci, at least one of a plurality of cerebral ventricles, and at least one of a plurality of anatomical regions in the subarachnoid space as non-bleeding regions, an appropriate region in the brain corresponding to the type of bleeding can be specified as a non-bleeding region. As a result, registration between the brain image B0 of the subject and the standard brain image Bs and region division of the brain image B0 of the subject can be more accurately performed.

In the embodiment described above, at least one of the sulcus, the cerebral ventricle, and the subarachnoid space is specified as a non-bleeding region. On the other hand, a plurality of sulci are present in the brain. For this reason, even though there is bleeding in one of the sulci, bleeding may not be observed in other sulci. In such a case, at least one of the plurality of sulci where bleeding is not observed may be specified as a non-bleeding region. In addition, in this case, one or more of at least one of a plurality of cerebral ventricles, the subarachnoid space and at least one of a plurality of anatomical regions in the subarachnoid space may be specified as non-bleeding regions.

In addition, a plurality of cerebral ventricles are present in the brain. For this reason, even though there is bleeding in one of the cerebral ventricles, bleeding may not be observed in other cerebral ventricles. In such a case, at least one of the plurality of cerebral ventricles where bleeding is not observed may be specified as a non-bleeding region. For example, in a case where bleeding is suspected in the first cerebral ventricle, the second cerebral ventricle may be specified as a non-bleeding region. In addition, in this case, one or more of at least one of a plurality of sulci, the subarachnoid space and at least one of a plurality of anatomical regions in the subarachnoid space may be specified as non-bleeding regions.

In addition, the subarachnoid space can be divided into a plurality of anatomical regions, such as cerebral valleys and ambient cisterns. For this reason, even though there is bleeding in one of the regions, bleeding may not be observed in other regions. In such a case, at least one of the plurality of anatomical regions in the subarachnoid space where bleeding is not observed may be specified as a non-bleeding region. For example, in a case where bleeding is suspected in the cerebral valley, the ambient cistern may be specified as a non-bleeding region. In addition, in this case, one or more of at least one of a plurality of sulci and at least one of a plurality of cerebral ventricles may be specified as non-bleeding regions.

In the embodiment described above, the diseased region specifying unit 25 may specify a diseased region using a machine learned discriminator. In this case, any discriminator that receives a difference between the first density distribution of the region A11 in the brain image B0 and the second density distribution of the region A12 of the selected standard brain image Bs as feature amounts and outputs a determination result indicating whether or not the region A11 is a diseased region may be used. For learning of such a discriminator, a number of density distributions of each divided region in a brain image known to be a diseased region and a number of density distributions of each divided region in a brain image known not to be a diseased region are prepared. Then, machine learning is performed using a difference value between the numerous density distributions, thereby generating a discriminator. As a method of machine learning, any known method, such as logistic regression and support vector machine, can be used. As a result of such learning, in a case where a difference value between the first density distribution in the certain region A11 of the brain image B0 and the second density distribution in the region A21 corresponding to the region A11 in the standard brain image Bs is input, the discriminator outputs a determination result indicating whether or not the region A11 of the brain image B0 is a diseased region. As a result, it is possible to specify the diseased region in the brain image B0.

In the embodiment described above, the CT image of the subject is used as a brain image. However, even in medical images other than MRI images, PET images, and CT images, the pixel values are different between the normal region and the diseased region in the brain. Therefore, a medical image other than the CT image may be used as a brain image.

Hereinafter, the effect of the present embodiment will be described.

A region where bleeding can occur in the brain differs depending on the type of bleeding. For example, subarachnoid hemorrhage tends not to occur in the cerebral ventricle. Intracerebral hemorrhage often occurs outside the subarachnoid space. Therefore, by setting one or more of at least one of a plurality of sulci, at least one of a plurality of cerebral ventricles, and at least one of a plurality of anatomical regions in the subarachnoid space as non-bleeding regions, an appropriate region in the brain corresponding to the type of bleeding can be specified as a non-bleeding region. As a result, registration between the brain image of the subject and the standard brain image and region division of the brain image of the subject can be more accurately performed.

What is claimed is:

1. A medical image processing apparatus, comprising:
an image acquisition unit that acquires a brain image including a brain of a subject;
a storage unit that stores a plurality of standard brain images having a plurality of types of shapes and sizes;
a non-bleeding region specifying unit that specifies a non-bleeding region in the brain image;
a selection unit that selects a standard brain image corresponding to at least one of a shape or a size of the non-bleeding region from the plurality of standard brain images; and
a division unit that divides a brain included in the brain image into regions based on the selected standard brain image.

2. The medical image processing apparatus according to claim 1,
wherein the non-bleeding region is one or more of at least one of a plurality of sulci, at least one of a plurality of cerebral ventricles, and at least one of a plurality of anatomical regions in a subarachnoid space.

3. The medical image processing apparatus according to claim 1,
wherein the non-bleeding region specifying unit specifies the non-bleeding region based on diagnostic information of the subject.

4. The medical image processing apparatus according to claim 1,
wherein the non-bleeding region specifying unit specifies the non-bleeding region based on the brain image.

5. The medical image processing apparatus according to claim 1, further comprising:
a diseased region specifying unit that specifies a diseased region including a disease in the region-divided brain image.

6. The medical image processing apparatus according to claim 5, further comprising:
a display control unit that displays the brain image, in which the diseased region is specified, on a display unit.

7. A medical image processing method, comprising:
acquiring a brain image including a brain of a subject;
specifying a non-bleeding region in the brain image;
selecting a standard brain image corresponding to at least one of a shape or a size of the non-bleeding region from a plurality of standard brain images having a plurality of types of shapes and sizes; and
dividing a brain included in the brain image into regions based on the selected standard brain image.

8. A non-transitory computer-readable storage medium that stores a medical image processing program causing a computer to execute:
a step of acquiring a brain image including a brain of a subject;
a step of specifying a non-bleeding region in the brain image;
a step of selecting a standard brain image corresponding to at least one of a shape or a size of the non-bleeding region from a plurality of standard brain images having a plurality of types of shapes and sizes; and
a step of dividing a brain included in the brain image into regions based on the selected standard brain image.
